(19) United States
(12) Patent Application Publication
(10) Pub. No.: US 2016/0180653 A1
(43) Pub. Date: Jun. 23, 2016

(54) Computerized Method of Selecting and Verifying Contest Winners

(71) Applicant: Fomula Inc Limited, Kowloon (HK)

(72) Inventors: Bryan Cooley, Rapid City, SD (US); Predrag Tomasevic, Elmhurst, IL (US)

(73) Assignee: Formula Inc Limited, Kowloon (HK)

(21) Appl. No.: 14/972,382

(22) Filed: Dec. 17, 2015

Related U.S. Application Data
(60) Provisional application No. 62/093,505, filed on Dec. 18, 2014.

(51) Int. Cl. G07F 17/32

(52) U.S. Cl. CPC G07F 17/3276; G07F 17/3286

(57) ABSTRACT

A computerized method for determining and verifying a result of a computerized game or contest is disclosed. The method comprises combining a client seed value, a server seed value, and a secret seed value into a combined seed value, entering the combined seed value into a decision making algorithm, executing the algorithm, determining an output value of the decision algorithm, establishing a preset value range, determining if the output value is within the preset value range, and generating an award if the output value is within the preset value range. The method is utilized to operate a game of chance. The method may be used for a single player game, a multiplayer lottery, or a multiplayer contest with a backup lottery. In the preferred embodiment, the method is utilized in an online auction contest with a backup lottery for players who do not win the auction.

### PRIORITY

This application claims priority to U.S. Provisional Patent Application No. 62/093,505 filed Dec. 18, 2014.

### FIELD OF THE INVENTION

The invention pertains generally to computerized gaming and more particularly to a computerized method of selecting and verifying contest winners.

### BACKGROUND OF INVENTION

Computerized games of chance are well known. Random number generation algorithms are used in machines such as slot machines or for automated bingo, keno, or other automated drawings. Multiple computer users may each be given a unique token or unique series of numbers. The algorithm generates one or more numbers or tokens. The user or users with the identical numbers or tokens will be deemed winner of the game. Multiple players enjoy games of chance because multiple players can win partial or complete rewards. These games of chance are limited. These games of chance run on automatic random number algorithms which are not open or obvious to players. An opportunity exists for game operators to exploit these hidden algorithms to trick players into thinking they are playing random games when in fact the algorithms utilized are stacked in favor of the game operator. For instance, a player may believe that he has a 50% of a chance of winning when in fact the algorithm utilized gives the player only a 45% chance of winning. What is needed is a game of chance utilizing user input to affect the outcome of the game so that the game operator has no knowledge of the chance of a specific outcome beforehand.

In addition, computerized contests and auctions are also well known. Different users can bid on items and attempt to win items by bidding a set amount. The user who places the highest amount on the item being auctioned wins the item. Additionally, users may bid on items incrementally, where each time a user places a bid on an item the price goes up by a unit (for example an increment of one penny). The last person to bid on the item within a given time is deemed the winner of the item and the price of the item is the ending price after the last person has bid on the item.

Each of these types of games or contests has certain limitations. Games of chance are limited in that those games are completely random. Each contestant has an identical chance of winning and there is no procedure for increasing a contestant's chances of winning beyond possibly purchasing more entries for a single drawing or single contest. Contests, auctions, and other games of skill are limited in that the prize is given to one individual or a small set of individuals in the case of multiple prizes and there is no reward or benefit for other contestants or players many of whom invested significant time, money, and/or effort into the skill game but did not win anything.

In addition, these games of chance are limited in that it is difficult for contestants to verify that a certain individual was the winner and that the organizer of the game is honest and truthful about who won and who lost the contest. What is needed is a computerized contest which rewards a contestant based on skill or tenacity while also employing an element of chance to provide an incentive for other contestants who do not win one of the skill based prizes and furthermore to provide a fair, provable selection process for the game of chance which cannot be manipulated by the game organizer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

A computerized method for determining a result of a computer based contest is disclosed. The method comprises receiving a client seed value, generating a server seed value, receiving a secret seed value, combining the client seed value, the server seed value, and the secret seed value into a combined seed value, entering the combined seed value into a decision making algorithm, executing the decision making algorithm, determining an output value of the decision making algorithm, establishing a preset value range, determining if the output value is within the preset value range, and generating an award if the output value is within the preset value range.

The method may further comprise receiving the client seed value, the server seed value, and the secret seed value in Base64 format, converting each of the client seed value, the server seed value, and the secret seed value respectively into a client seed value byte array, a server seed value byte array, and a secret seed value byte array, concatenating the client seed value byte array, the server seed value byte array, and the secret seed value byte array into a combined byte array, calculating a SHA512 hash value for the combined byte array, converting the hash value into a hexadecimal string, segregating a first set of characters from the hexadecimal string, converting the first set of characters into a long integer, and identifying the long integer as the combined seed value.

The method may further comprise generating a combined seed input value, wherein the combined seed input value includes at least one of a random input value, a user input value, a time value, and a client identity value and transforming the combined seed input value into the client seed value. The random input value is randomly generated by a computer. The user input value is dependent upon a chosen input by a user of a computer. The time value is dependent upon the time of creation of the time value. The client identity value is dependent upon the identity information of a computer creating the client identity value.

The method may further comprise assigning a transaction identification number to an execution of the decision making algorithm, storing information related to the execution of the decision making algorithm, receiving a request to verify a transaction outcome, requesting input of a transaction identification number, receiving an input of a transaction identification number, retrieving a set of stored information related to the execution of the decision making algorithm, displaying a server seed value utilized in the execution of the decision making algorithm, displaying a secret seed value utilized in the execution of the decision making algorithm, requesting input of a confirmation client seed value, receiving a confirmation client seed value, combining the confirmation client seed value, the server seed value, and the secret seed value into a confirmation combined seed value, entering the confirmation combined seed value into the decision making algorithm, executing the decision making algorithm, determining a confirmation output value of the decision making algorithm, and displaying the confirmation output value on a display screen.

In another embodiment of the invention the computerized method for determining a result of a computer based contest comprises receiving, by a server computer, a plurality of client seed values from a plurality of client computers, assigning an order value to each of the client seed values, generating a server seed value, receiving a secret seed value, electing one or more client seed values from the plurality of client seed values, combining the one or more elected client seed values, the server seed value, and the secret seed value into a combined seed value, inputting the combined seed value into a decision making algorithm, executing the decision making algorithm, determining an output value of the decision making algorithm, wherein the output value is an integer having a lower limit value of 1 and an upper limit value equal to the number of client seed values received, determining an identity of a first client computer whose assigned order value of the client seed value submitted is equal to the output value, electing the first client computer for the receipt of an award, and generating an award to a client computer.

The method may further comprise placing an award restriction on a client computer and saving the award restriction as an award restriction data file in a database on a server computer. The method may further comprise searching a database containing award restriction data files on a server computer, determining if an award restriction data file identifying the first client computer exists in the database, cancelling the election of the first client computer for the receipt of an award, electing one or more alternate client seed values from the plurality of client seed values, combining the one or more elected alternate client seed values, the server seed value, and the secret seed value into an alternate combined seed value, inputting the alternate combined seed value into a decision making algorithm, executing the decision making algorithm, determining an alternate output value of the decision making algorithm, wherein the alternate output value is an integer having a lower limit value of 1 and an upper limit value equal to the number of client seed values received, determining an identity of an alternate client computer whose assigned order value of the client seed value submitted is equal to the alternate output value, and electing the alternate client computer for the receipt of an award.

In another embodiment the computerized method for determining a result of a computer based contest comprises receiving, by a server computer, a plurality of client seed values from a plurality of client computers, assigning an order value to each of the client seed values, select a predetermined order value, determining the identity of a first client computer whose assigned order value of the client seed value submitted it equal to the predetermined order value, electing the first client computer for the receipt of an award, generating an award to the first client computer, generating a server seed value, receiving a secret seed value, electing one or more client seed values from the plurality of client seed values, combining the one or more elected client seed values, the server seed value, and the secret seed value into a combined seed value, inputting the combined seed value into a decision making algorithm, executing the decision making algorithm, determining an output value of the decision making algorithm, wherein the output value is an integer having a lower limit value of 1 and an upper limit value equal to the number of client seed values received, determining an identity of a second client computer whose assigned order value of the client seed value submitted is equal to the output value, electing the second client computer for the receipt of an award, and generating an award to the second client computer.

The method in this embodiment may further comprise placing an award restriction on a client computer and saving the award restriction as an award restriction data file in a database on a server computer. The method as may further comprising searching a database containing award restriction data files on a server computer, determining if an award restriction data file identifying an elected client computer exists in the database, and cancelling the election of the elected client computer for the receipt of an award. The method may further comprise selecting an alternate predetermined order value when the first client computer is identified as having an award restriction, determining the identity of an alternate first client computer whose assigned order value of the client seed value submitted it equal to the alternate predetermined order value, electing the alternate first client computer for the receipt of an award, and generating an award to the alternate first client computer. The method may further comprise electing one or more alternate client seed values from the plurality of client seed values when the second client computer is identified as having an award restriction, combining the one or more elected alternate client seed values, the server seed value, and the secret seed value into an alternate combined seed value, inputting the alternate combined seed value into a decision making algorithm, executing the decision making algorithm, determining an alternate output value of the decision making algorithm, wherein the alternate output value is an integer having a lower limit value of 1 and an upper limit value equal to the number of client seed values received, determining an identity of an alternate client computer whose assigned order value of the client seed value submitted is equal to the alternate output value, and electing the alternate client computer for the receipt of an award.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of the system utilizing the invention;

FIG. 2 is a schematic of the system utilizing the invention;

FIG. 3 is a schematic of the system utilizing the invention;

FIG. 4 is a schematic of the system utilizing the invention;

FIG. 5 is a schematic of the method of the invention;

FIG. 6 is a schematic of the method of the invention;

FIG. 7 is a schematic of the method of the invention;

FIG. 8 is a schematic of the method of the invention;

FIG. 9 is a schematic of the method of the invention;

FIG. 10A is a schematic of the method of the invention;

FIG. 10B is a schematic of the method of the invention;

FIG. 11 is a schematic of the method of the invention;

FIG. 12 is a display of a game utilizing the method of the invention;

FIG. 13 is a display of a game utilizing the method of the invention; and

FIG. 14 is a display of a game utilizing the method of the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

The invention is directed toward a computerized method of combining a skill game with a game of chance. In addition, the invention is directed toward a fair method of selecting and verifying the results of a computerized game of chance. Although the primary example used here to illustrate the invention is the combination of an incremental auction (penny auction) with a secondary prize (lottery or raffle), the general more general invention can be applied by replacing either the game of skill or the game of chance with an alternative skill game or chance game respectively.

The invention will be described herein with regards to the preferred embodiment. However, other embodiments and methods may be practiced without departing from the scope of the invention. The various components of the invention will be described with reference to the preferred embodiment. It should be understood that not all components need be present in the utilization of the invention and that the separate components of the invention may be practiced independently without departing from the scope of the invention.

### SYSTEM OF THE INVENTION

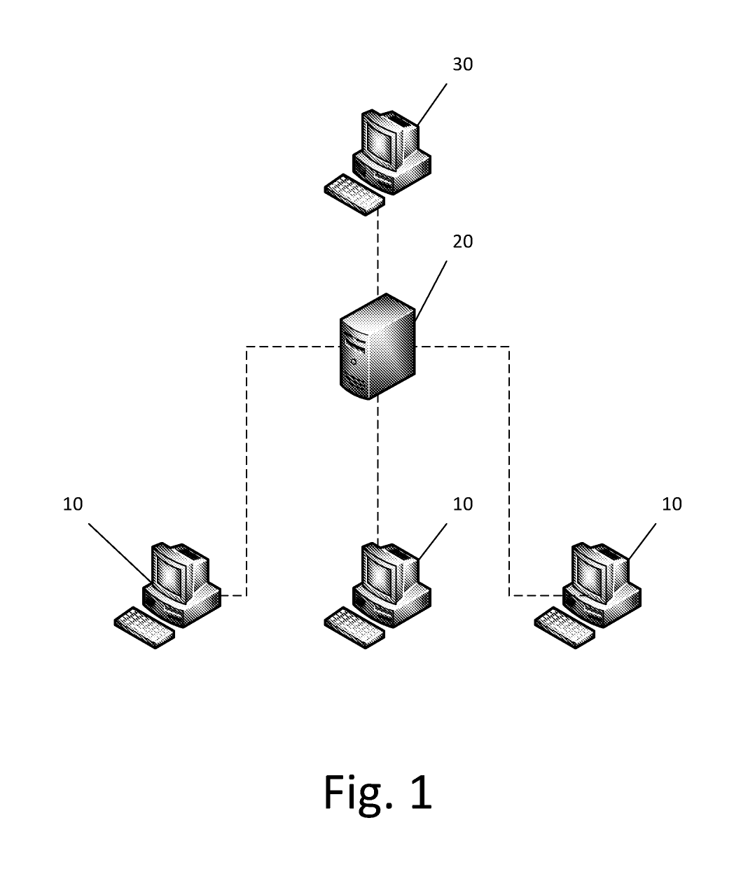

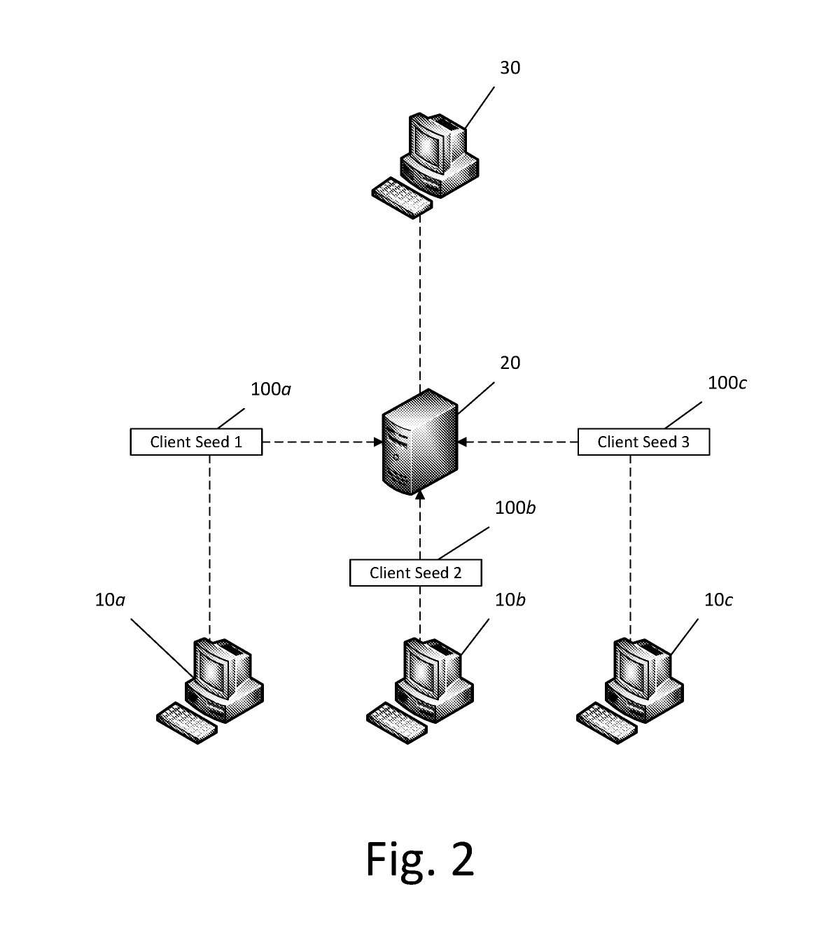

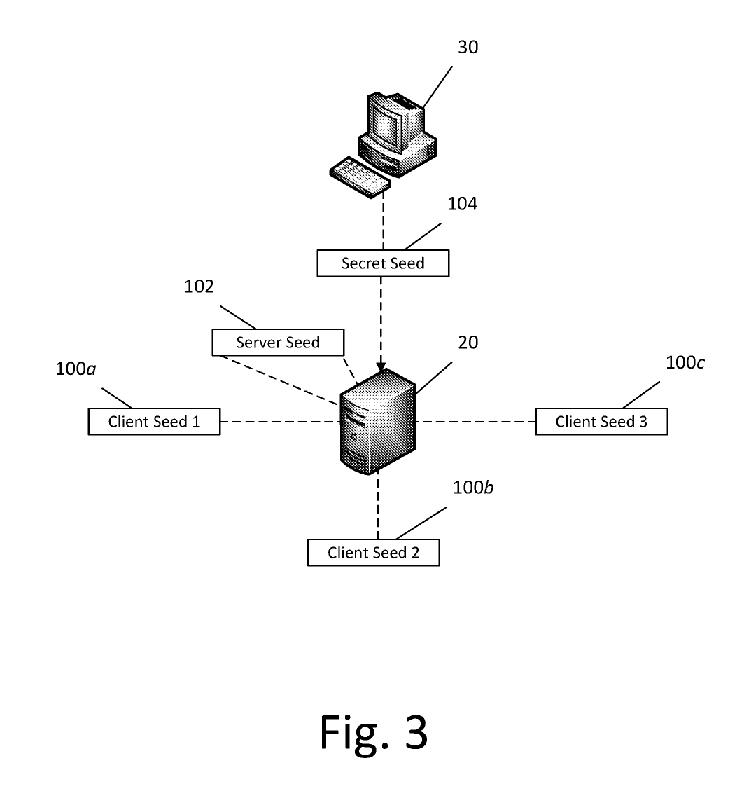

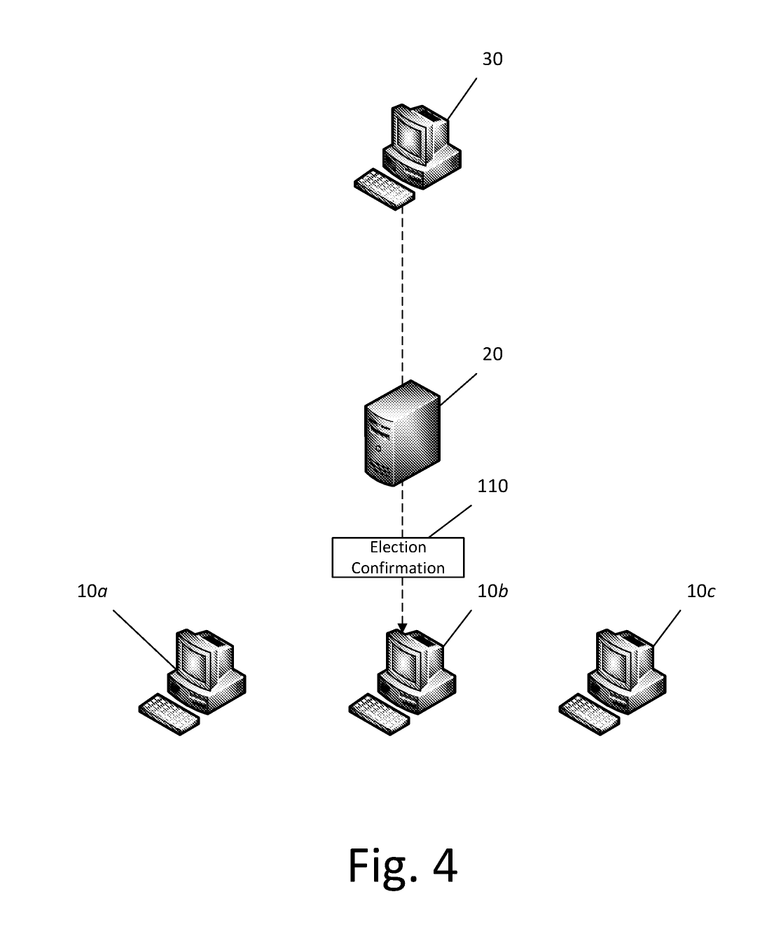

Referring to FIG. 1 through FIG. 4 the system utilizing the invention is displayed. As shown in FIG. 1, the system comprises a plurality of client computers 10 communicatively coupled to a server computer 20. In addition, an operator computer 30 is communicatively coupled to the server computer 20. FIG. 2 through FIG. 4 displays a competitive game or lottery game between multiple users utilized through the system. As shown in FIG. 2, in this system a first client computer 10a submits Client Seed 1 100a to the server computer 20. A second client computer 10b submits Client Seed 2 100b to the server computer 20. A third client computer 10c submits Client Seed 3 100c to the server computer 20. As shown in FIG. 3, the server 20 generates a Server Seed 102 and the operator computer 30 generates and transmits a Secret Seed 104 to the server computer 20. The server computer 20 selects Client Seed 1 100a, Client Seed 2 100b, or Client Seed 3 100c. The server computer 20 combines the selected client seed with the Server Seed 102 and the Secret Seed 104 to form a combined seed. The server computer 20 performs a hash algorithm with the combined seed generate an output value which dictates the selection of the first client computer 10a, the second client computer 10b, or the third client computer 10c. As the example illustrates in FIG. 4, the server computer elects the second client computer 10b and transmits an election confirmation 110 to the second client computer 10b.

In other embodiments of the invention the system may be utilized by a single client computer 10 connected to a server computer 20. In this embodiment a user of the client computer 10 can play a single player game on the server computer 20—such as a dice game or a blackjack game. In this embodiment, the server computer 20 uses the client seed submitted by the client computer 10 to determine the outcome value. The server computer 20 in this embodiment sends the election confirmation 110 to the client computer 10 when the server computer 20 determines that the output of the algorithm dictates that the user has won the game.

In other embodiments the client computer 10, server computer 20, and operator computer 30 may be combined into a single stand-alone machine. In other embodiments the server computer 20 may run a multi-player game using Artificial Intelligence (A.I.) units as co-players. In this embodiment the server computer 20 randomly generates client seeds to use for the A.I. players.

In the preferred embodiments, the gaming method is presented through a network of computerized devices. The software is housed on a network server or servers connected to a plurality of client servers. The manager of the game manages the software on the network server(s) and the contestants connect and interact with the software through the plurality of client devices (for example laptops, desktop computers, mobile phones, tablets, smart televisions, smart appliances, or other interactive devices). The client device could also be a non-physical entity such as computer software (an automated playing system for example) or alternatively games could also be played via a telecommunication network (sending emoticons, playing via a chat tool, or using SMS, touch tones, or voice commands) or via radio (short wave radio for example). The system may have further software components to increase the benefit and utilization of the software. For instance, the software may further use a chat component permitting contestants to interact and text with one another. The system may further be limited to contestants utilizing a user id and password to access the software.

### Computerized Selection Process

The invention is also directed toward a novel computerized method of selection of a winner of a lottery game and verification of the winner of a game (whether the game was a game of skill or a lottery).

The selection process utilizes a secret seed, a server seed, and a client seed. The selection process is a computerized method utilized to determine the winner of a game of skill or the winner of a game of chance. The selection process begins when an activation signal is received from a client computer. The contestant generates an activation signal from the client computer which is transmitted to the server computer. The activation signal comprises a client seed. The client seed can be any number or value that is randomly generated by the client computer or a predetermined number or value specifically chosen and entered by the contestant.

The server computer generates a server seed. The server seed is specifically generated when the server computer receives the activation signal from the client computer. The server seed may be a randomly generated number or value or may be a number generated based upon a predetermined factor—such as time that the activation signal is received by the server computer.

The server computer also stores a secret seed. The secret seed may be a randomly generated number or value or the secret seed may be a number or value which is specifically chosen by the manager of the gaming system. In the preferred embodiment, the secret seed is set for a certain predetermined amount of time. For instance, in this embodiment, the secret seed is changed on a daily basis but could be changed on a shorter or longer time interval or alternatively on a variable interval. This change in the secret seed permits later verification of the selection process without jeopardizing the integrity of the gaming system.

During the selection process the client seed, server seed, and secret seed are added together. The server computer then applies a hash algorithm to the combined seeds. The hash algorithm is configured to generate a series of predetermined values depending on the value of the client seed and the server seed. As either the client seed or the server seed changes, the resulting hash value is changed. The software system is configured to have a predetermined “winning” hash value. For instance, if the hash algorithm is configured to result in five possible predetermined values, the manager of the gaming system can establish a single value as the winning value. When a contestant sends an activation signal to the server computer, if the resulting generated hash is equal to the winning value then the contestant has won. If the resulting generated hash is not equal to the winning value then the contestant has not won. In this illustration, the contestant has a one in five chance of winning.

Unlike games of chance where contestants have no control over their opportunity for winning, the present selection process provides for a game of chance where a contestant has a modicum of control over the selection process. The contestant may choose to modify the client seed prior to sending an activation signal to the server computer. Thus, the contestant has the opportunity to influence the selection process.

In some embodiments, the client seed may not be directly modified or specified by the contestant. For instance, in a lottery game, the client seed is automatically specified by the client computer when the contestant places a bid. In an incremental auction contest, the client seed may be dependent upon information relevant to the bid of the contestant—such as the time the bid is placed and the bid amount.

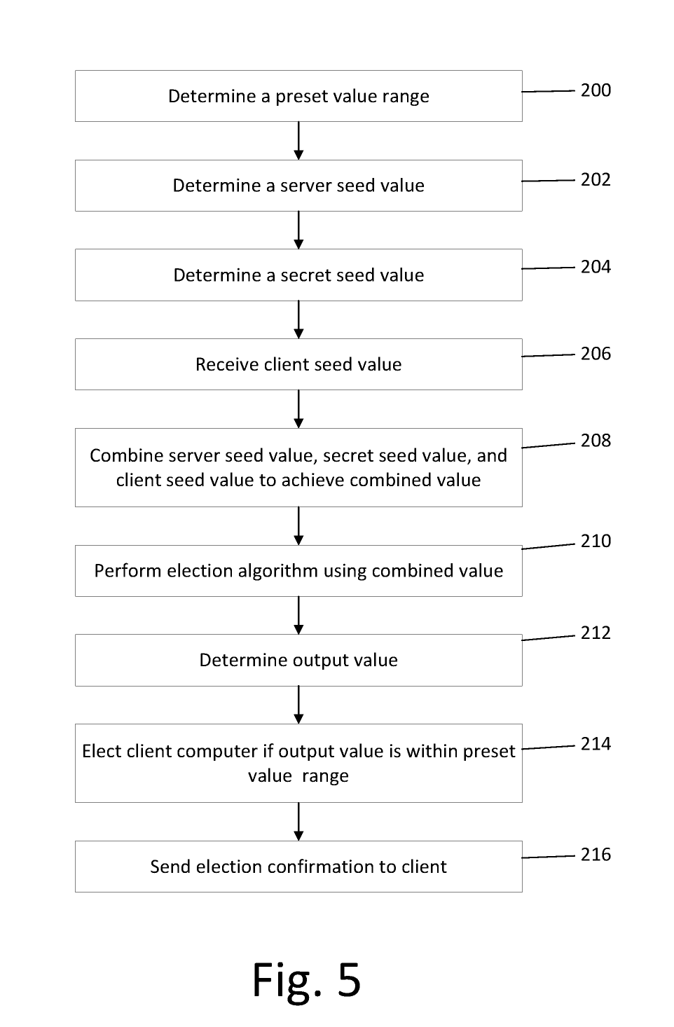

Referring to FIG. 5, the method of the system performing a game of chance is illustrated. First, the system determines a preset value range 200. The preset value range may be any range of numbers determined to be winning values in the computerized game. In addition, the preset value range may be a single specific number, specific range of numbers, a specific fraction of a number, or a range of fractions of a number. The system determines a server seed value 202. The system also determines a secret seed value 204. The system receives a client seed value from the client computer 206. The system combines the server seed value, secret seed value, and client seed value to obtain a combined seed value 208. The system performs an election algorithm using the combined seed value 210. The system determines an output value from the algorithm 212. The system determines if the output value is within the preset value range and elects the client computer if the output value is within the preset value range 214. The system then sends an election confirmation to the client computer 216.

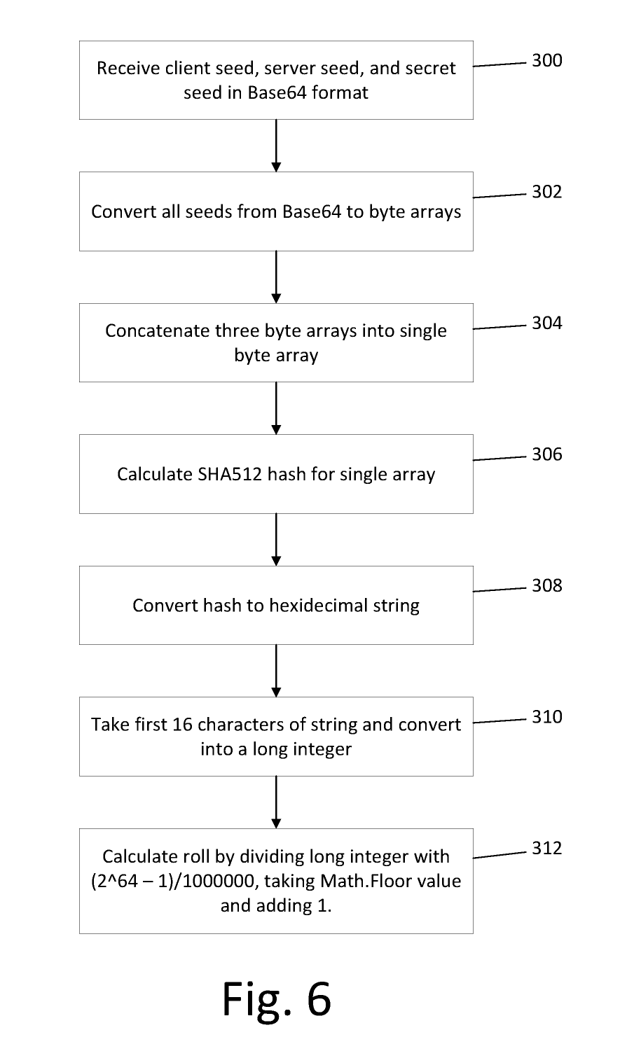

The method of single player game of dice using the inventive method is illustrated in FIG. 6. First the system receives a client seed value, a server seed value and a secret seed value in Base64 format 300. The client seed value, server seed value, and secret seed value each may be any alphanumeric number or value. In the preferred embodiment the client seed value, server seed value, and secret seed value are each larger than 1 byte and smaller than 1024 bytes. The system converts all seeds from Base64 format to byte arrays 302. The system then concatenates the three byte arrays into a single byte array 304. The system then calculates an SHA512 hash for the single byte array 306. The system then converts the resulting hash into a hexadecimal string 308. The system takes the first 16 characters of the hexadecimal string and converts it into a long integer 310. The system will use the resulting long integer in separate ways depending on the game played and will alter the decision algorithm utilized depending on the game. In the example method illustrated where the game is a roll of dice the system calculates the roll by diving the long integer with (2̂64−1)/1000000, taking the Math.Floor value, and adding one 312.

### Lottery Game

The invention may be utilized to play a lottery game among separate users. In a lottery game each contestant for the lottery submits a client seed to the server computer. The last contestant to submit an entry effects the outcome of the lottery. The system takes the client seed submitted from the last contestant. The system combines the last submitted client seed and combines it with the server seed and secret seed. The system then hashes the combined seeds to generate a hash value. The hash algorithm is configured to generate a number between one and the number of entries received. Each entry is given a number in the order received by the server computer. The result of the hash algorithm is then matched to the appropriate entry that was submitted at the resulting number. For instance, if the result is seventeen then the contestant who submitted the seventeenth entry received by the server computer is determined the winner of the lottery. If there is a second place prize won then the system utilizes the client seed submitted by the next to last contestant to determine the second place prize.

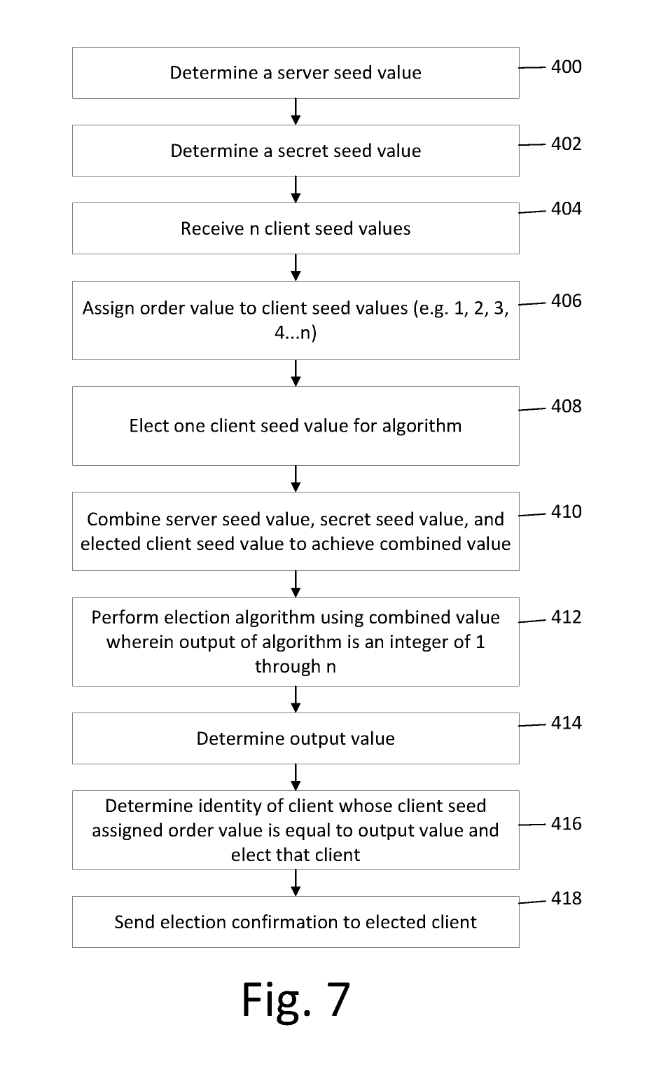

The preferred embodiment of the lottery method is illustrated in FIG. 7. First the system determines a server seed value 400. The system determines a secret seed value 402. The system then receives n client seed values 404. In the preferred embodiment each user submits only one client seed where n equals the number of users playing. In other embodiments each user may submit multiple client seeds and n equals the total of client seeds submitted. The system assigns an order value to each of the client seed values (e.g. 1, 2, 3, 4 . . . n) 406. In the preferred embodiment the order value is the order in which each client seed was received so that the first client seed received has an order value of 1. In other embodiments the order value is in reverse order chronologically so the last client seed received by the system has an order value of 1. The system then selects one client seed out of the n client seeds to use in the algorithm 408. In the preferred embodiment the system selects the client seed value which was submitted last in time. In other embodiments the system can randomly select any client seed value to utilize. The system combines the server seed value, secret seed value, and the elected client seed value to achieve a combined seed value 410. The system then performs an election algorithm using the combined value to generate an output value, where the output value is an integer of 1 through n 412. The system determines the output value of the election algorithm 414. The system them determines the identity of the client computer whose client seed assigned order value is equal to the output value and then elects that client computer 416. The system then sends an election confirmation to the elected client computer 418.

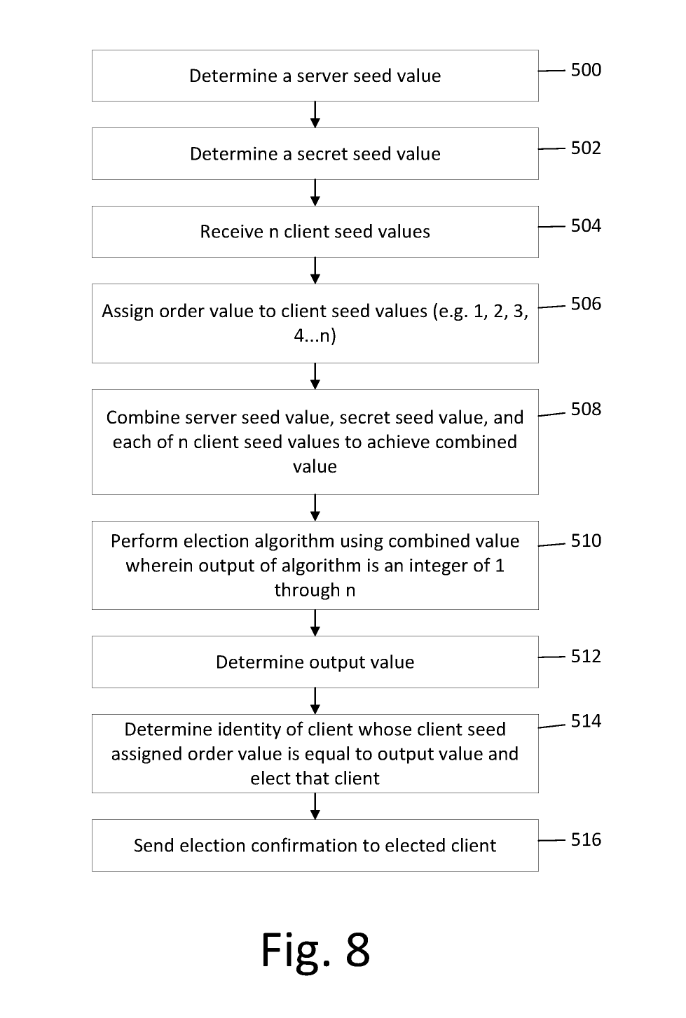

In another embodiment of the invention, the system utilizes all client seed values submitted in the election algorithm so that each user playing the game influences the outcome. This embodiment of the inventive method is illustrated in FIG. 8. In this embodiment of the method the system determines a server seed value 500. The system determines a secret seed value 502. The system then receives n client seed values 504. The system assigns an order value to each of the client seed values (e.g. 1, 2, 3, 4 . . . n) 506. The system combines the server seed value, secret seed value, and each of the n client seed values to achieve a combined seed value 508. The system then performs an election algorithm using the combined value to generate an output value, where the output value is an integer of 1 through n 510. The system determines the output value of the election algorithm 512. The system them determines the identity of the client computer whose client seed assigned order value is equal to the output value and then elects that client computer 514. The system then sends an election confirmation to the elected client computer 516.

### Generation of Client Seed Value

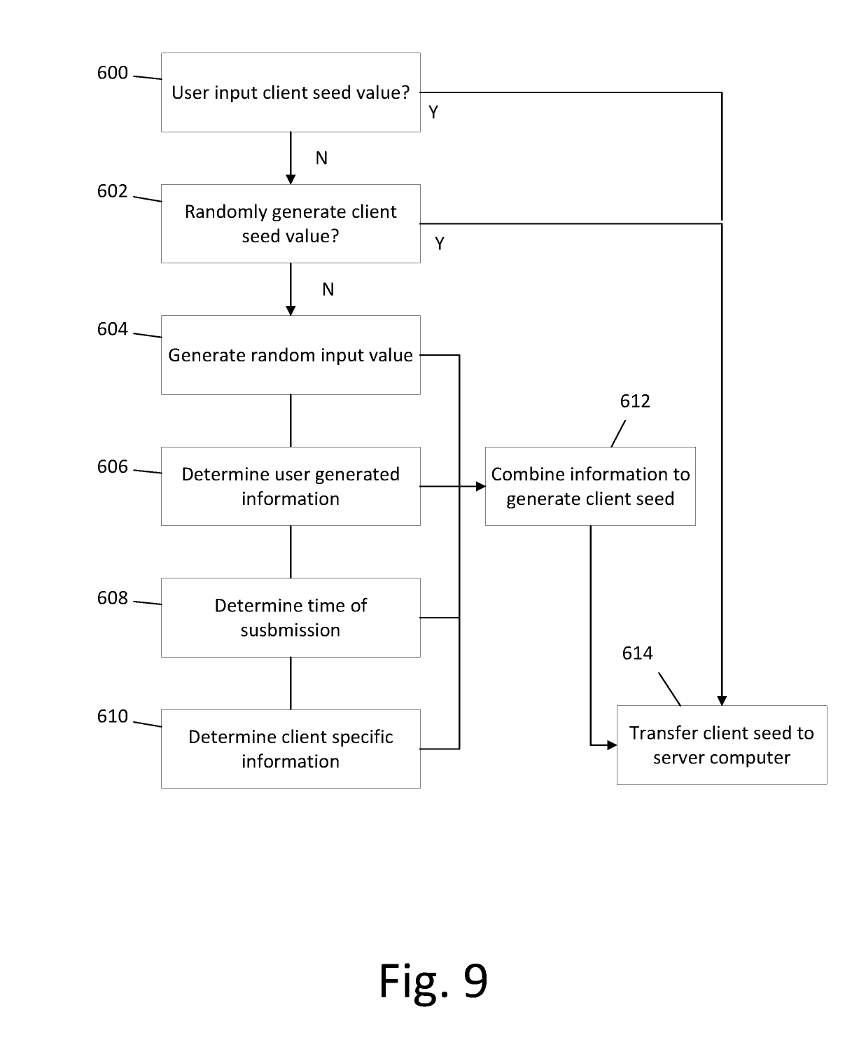

The client seed value can be determined in a number of ways as illustrated in FIG. 9. The method illustrated in FIG. 9 displays the creation of a combined input seed value. The combined input seed value can include any combination of a random input value, a user input value, a time value, and a client value—such as only a random input value, only a client value, a combination of random input value and client value, or any other possible combination of values. First the user can input the client seed value 600. If that value is used then the client computer transfers the client see value to the server computer 614. In addition, the client computer can randomly generate a client seed value 602. The client computer then transfers the randomly generated client seed value to the server computer 614. In addition, the client computer may utilize a series of attributes to affect the value which is generated. First, the client computer may randomly generate an input value 604. Next the client computer determines whether there is any user generated information 606. The user generated information may be any information selected or input into the calculation by the user. This may include a specific input of the full client seed value which is combined with the randomly generated input. In addition the user generated information may be an alphanumeric input typed into by the user, a specific selection of a certain screen icon by the user, a data file uploaded by the user, or any other data or information which is generated or chosen by the user. The client computer may also determine the time of submission 608. In this step, with all other attributes being equal, a different client seed value is generated with a change in time of generation. The client may also determine client specific information 610. The client specific information may include any information which is specific to identifying the client computer, such as a port number, a computer ID number, a media access number, IP address, or any other information which is specific to the client computer utilized. With all other attributes being the same, the generated client seed value would be different when the user changes client computers to generate the client seed value. The client computer combines the attributes to generate the client seed value 612. Any combination of these attributes may be used to generate the client seed value. The client computer may use one or all attributes to generate the client seed value. The client computer then transfers the client seed value to the server computer 614.

### Game of Skill and Lottery

In one embodiment of the invention, one component of the invention is an incremental auction contest—also commonly known as a penny auction. In the incremental auction contest a prize is offered to a plurality of contestants for a specific amount of time. Any number of contestants may place a bid for the final award. The final award in incremental auctions is typically a retail item such as a mobile phone, DVD player, or handbag. In the invention embodiment, the final award also includes tokens, prizes, money, bitcoins, fiat currency, virtual currency, crypto currency, benefits, vouchers, coupons, store credits, gift cards, mobile phone credits, stocks, bonds, derivatives, real estate, precious metals, virtual items, CPU time, hash power, or any other type of award. The incremental auction contest is set to proceed for a predetermined amount of time. At the expiration of the predetermined amount of time, the last person to place a bid is determined the winner. In the incremental auction contest the prize is offered to a number of contestants. As each contestant places a bid for the prize the cost of the prize increases by a predetermined amount. For instance, as one example of this component, an award of a television may be offered to a plurality of contestants. The price for the television may start at one cent. Each time a contestant places a bid for the television the price increases by one cent. For instance, if only five bids are placed then the last bid will be for six cents and the contestant who placed the bid for six cents will win the television for a cost of six cents (plus the cost of whatever bids they spent in winning the prize). Note that the cost of each bid in this case would generally be much higher than the bid increment (for example the price of each bid price may be 50 cents). In most cases, the auction will be “winner takes all” with no bids refunded and users who bid but did not win would be out of pocket whatever bids they spent trying to win the incremental auction prize.

The contest may proceed for a predetermined amount of time. In other embodiments, the remaining amount of time may increase as each bid is placed. For instance, when a bid is placed the remaining amount time may increase by ten seconds. In other embodiments, the remaining amount of time may be reset to certain time limit as each bid is placed (clock is reset to 15 seconds for example). In other embodiments, the remaining amount of time may be increased or reset to a particular value only if the remaining amount of time is below a certain threshold. For instance, if the remaining amount of time is over thirty seconds then no additional time may be added to the remaining amount of time and the clock will countdown each second from the current countdown time. However, if the remaining amount of time is less than thirty seconds then ten seconds of additional time could be added on to the remaining amount of time or the time could be instead be reset to say twelve seconds for example.

In the preferred embodiment, the incremental auction contest is complemented by a lottery system. As each contestant places a bid for the final award, that contestant is entered into a lottery for an additional prize. Each contestant is given an entry to the lottery when a bid is placed. A contestant may receive an entry for each instance when the contestant places a bid in the incremental auction contest. In other embodiments, the contestant may only receive a single entry into the lottery regardless of the number of bids placed in the incremental auction contest. When the winning contestant is awarded the prize, the remaining contestants are entered into a lottery system for an additional prize. As an illustration of the component, and by no means limiting the scope of the invention, ten total bids may be placed during the incremental auction contest for the final award. Assuming that the ten bids are placed by three people—the winner placing a single winning bid, a second person placing six bids, and a third person placing three bids. In this illustration there are ten total entries into the lottery system—the first person receiving one entry, the second person receiving six entries and the third person receiving three entries. In this illustration the odds of winning the additional lottery prize is dependent upon the number of bids placed in the incremental auction contest. Thus, in this illustration the first person has a ten percent chance of winning the lottery content, the second person has a sixty percent chance of winning the lottery contest and the third person has a thirty percent chance of winning the lottery contest. In this case, the winner of the incremental auction contest was entered into the lottery contest as well. The system is envisioned in such a way that the winners in an incremental auction contest can either be included or excluded from participating in the lottery prizes as well depending on configuration of game parameters.

In other embodiments, there may be multiple winners of the lottery system, where each of the winning contestants wins a certain prize or certain percentage of the prize pool.

In other embodiments, there may be an additional lottery or game of chance that pools together users from multiple instances of one or more skill based games (for example 2 incremental auctions, 1 poker game, and 1 blackjack game). In other embodiments, there may be multiple lotteries or games of chance that users from one or more skill based game will participate in. In other words, the invention supports one-to-many, many-to-many, and many-to-one relationships in combining skill based games with games of chance.

In other embodiments, there may be multiple winners of the incremental auction system, where each contestant wins a certain prize or certain percentage of the prize pool based on being last bidder, next to last bidder, third to last bidder, and so forth. In some instances the same user could win more than one of the prizes if multiple bids are allowed in a row. In other embodiments with multiple auction winners, each user can only win one prize.

In other embodiments the final prize may be a prize pool of money. In this embodiment, the winner of the incremental auction contest, the winner of the lottery game, and the manager of the games may divide the prize pool of money. The percentage earned by each may be variable and any percentage of division may be applied. For instance, the winner of the incremental auction contest may receive seventy percent of the prize pool, the winner of the lottery may receive twenty percent of the prize pool, and the manager of the games may receive ten percent of the prize pool.

In one embodiment of the invention these components are coextensive and adjust in real time as contestants place bids. For instance, the number of contestants and number of entries into the lottery system constantly changes as bids are placed in the incremental auction contest. The odds of winning the lottery contest may be displayed and updated as contestants place bids for the incremental auction contest.

In other embodiments the incremental auction contest is separate from the lottery contest. Contestants may engage in an incremental auction contest without engaging in a lottery game. Alternatively, contestants may engage in a lottery game without engaging in an incremental auction contest. The manager of the games may customize the system so that each instance of the game may be different and contain any component, or any prize amount.

In some embodiments the software may utilize an autobid method whereby a contestant instructs the software to automatically bid for the final prize any time a bid is placed by another contestant or automatically bid according to another structure such as “bid in the last 2 seconds if total bid activity by all users is under a certain threshold”. In other embodiments, the game presented by the software may not be an incremental auction contest but another computerized game of skill. The other game of skill may include, but not be limited to a game of rock-paper-scissors, a game of scrabble or similar word game, a game of dice, a game of poker, a game of blackjack, a game of sic Bo, a game of craps, binary options, peer-to-peer betting game, sports betting, board game, trivia game, or any other game of skill or partially based on skill and this includes non-casino games and non-board games as well. In this embodiment, the game of skill may be paired with a lottery game so that the contestants who lose the game of skill may be awarded a prize through the lottery contest and thus have an incentive to further play the game of skill.

In another embodiment of the invention the system may be set up to limit the number of times that an individual may win. For instance, if one person wins a game of skill or lottery contest then the same individual may not be able to win a game of skill or a lottery contest for a set amount of time. The winning restriction may be compartmentalized to an individual type of game so that if an individual wins a game of skill then the individual may still win a lottery contest but may not win another game of skill. The winning restriction may also be compartmentalized to an individual game so that if a user wins a particular game then that user may not win at that game again for a set amount of time but may win at any other type of game. The winning restriction may also be utilized in incremental auctions performed by the system. In another embodiment, the winning restriction may be set based on the amount or value of the prize won by the contestant. For instance, if a user has won a prize valued between $100 and $500 then the user may be restricted from participating for a preset amount of time, such as for twenty-four hours in games at that prize level. Alternatively, winners may be permitted to participate but may be restricted from winning a lottery game of skill. In this scenario, a winner may still participate in a game of skill and win or lose the prize for the game of skill but will be restricted from winning any secondary lottery contest for those who do not win. Alternatively, the winning restriction may be based on number of wins in a set time. For instance, a user may be restricted to only two wins per week. On the flip side, some games may be set to only be playable by those who have never won any contest or have won less than a certain number of contests in a fixed period of time or for all time.

In other embodiments of the invention users of multiple lottery contests or games of skill may be automatically entered into a secondary game of skill or lottery contest. For instance, if there are two separate lottery games that each have their own winner then the losing contestants of each game may be entered into a second lottery contest. In this example the odds of winning the second lottery game may be dependent upon the number of individuals participating in the second lottery contest. In other embodiments, the odds of winning the second lottery game may be independent from the number of individuals participating in the second lottery contest and based on some other measure.

In another embodiment of the invention, the users may bid any type of token, item, or currency in the incremental auction contest. For instance, users may bid actual money or currency in the incremental auction contest rather than tokens. The money bid may be in any denomination or currency, such as dollars, euros, or any other fiat currency. Alternatively, users may also bid tickets or tokens which they have purchased prior to bidding. Alternatively, users may bid bitcoins or any other type of alternative currency, commodity, or other asset class including for instance virtual currencies, digital currencies, crypto currencies, mobile phone credits, precious metals, coupons, options, derivatives, equities, and bonds. The amount bid may be preestablished single units such as a single penny, single ticket, single satoshi, ounce of gold, stock certificate, etc. Alternatively, the amount bid may be multiple units, such as five pennies, eight tickets, 2 bitcoins, etc. or fractional units (2.5 dollars, 0.25 bitcoin, etc.) if the unit is divisible. Alternatively, a user may insert any desired amount for a single bid. In this case an individual user might set the bid increment of their choosing.

In other embodiments, variations of games of skill or lottery contests may be employed. For instance, parameters may be changed for each game. For instance, in some games users may be required to “ante up” a set amount before engaging in a game or in the middle of a game. Alternatively, bids in an incremental auction contest may get progressively larger over time. Alternatively, bids in an incremental auction contest may get progressively larger based on a certain number of bids received. Alternatively games may be limited to a fixed number of individuals based on selection criteria such as first-come-first-served, entry free, previous wins, geography, and experience level for example. Alternatively, other mechanisms may be utilized increase bid cost or speed up the play of a game, such as reducing the minimum countdown on clock reset or having the clock run faster or skip ahead in certain instances.

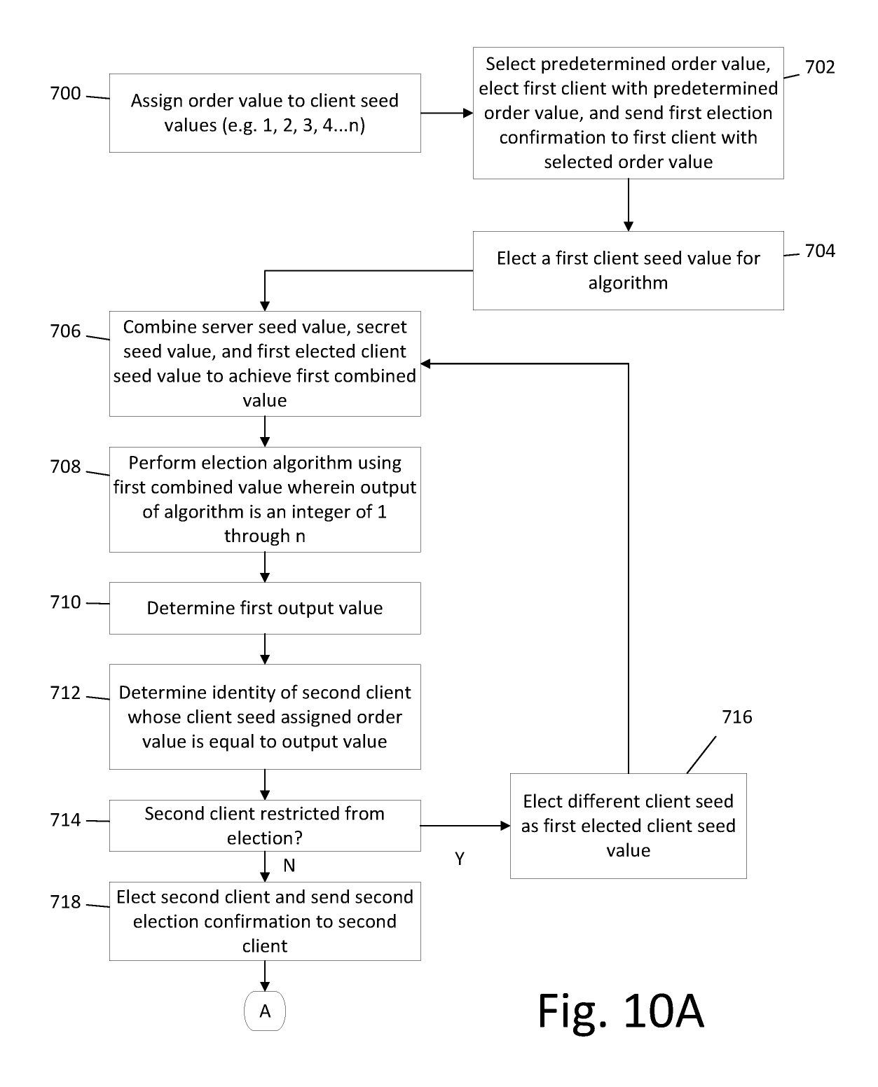

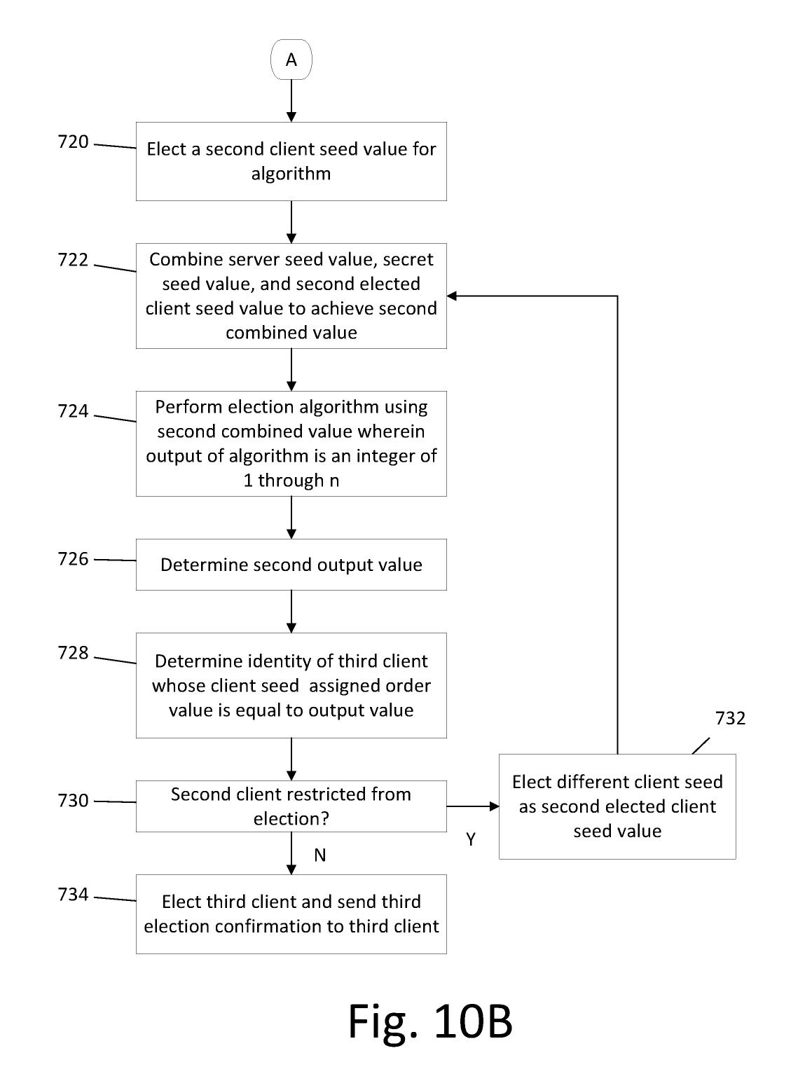

The combined method of a first game or contest combined with a lottery is illustrated in FIG. 10A and FIG. 10B. First, the system assigns an order value to the client values received (e.g. 1, 2, 3, 4 . . . n) 700. For the first game or contest the system selects a predetermined order value, elects a first client computer having the predetermined order value, and sends a first election confirmation to the first client computer having the selected order value 702. The system then selects a first client seed value for use in the selection algorithm 704. The system combines a server seed value secret seed value, and first elected client seed value to achieve a first combined seed value 706. The system performs an election algorithm using the first combined seed value where the output of the algorithm is an integer of 1 through n 708. The system determines a first output value 710. The system then determines the identity of a second client computer whose client seed assigned order value is equal to the output value 712. The system determines whether the second client is restricted from election (such as the owner of the second client has previously won) 714. If the second client is restricted from election the system elects a different client seed as the first elected client seed value and executes the algorithm again 716. If the second client has not restrictions then the system elects the second client and sends a second election confirmation to the second client 718. If there are multiple lottery winners then the method continues with the system electing a second client seed value for the algorithm 720. The system combines a server seed value secret seed value, and second elected client seed value to achieve a second combined seed value 722. The system performs an election algorithm using the second combined seed value where the output of the algorithm is an integer of 1 through n 724. The system determines a second output value 726. The system then determines the identity of a third client computer whose client seed assigned order value is equal to the second output value 728. The system determines whether the third client is restricted from election (such as the owner of the third client has previously won) 730. If the third client is restricted from election the system elects a different client seed as the second elected client seed value and executes the algorithm again 732. If the third client has no restrictions then the system elects the third client and sends a third election confirmation to the third client 734. The method may continue cycling through these steps to select multiple winners either for back up prizes or shared prize pools.

### Computerized Verification Process

The invention also provides for a novel method of permitting third parties to verify the winner of the game of skill or game of chance. In this manner those contestants who do not win can verify that the game was legitimate and the manager of the game did not manipulate the outcome of the game. At the time the game is played the hash algorithm, client seed, and server seed are open and may be known to all contestants and the manager of the game. The secret seed is known to the manager of the game but not to any contestant. The manager of the game does not have ultimate control over the outcome of the game because the contestant can manipulate the client seed and the manager does not know what the client seed will be in advance. After a predetermined amount of time the manager can change the secret seed and disclose the previously used secret seed. At that point in time any contestant may verify the outcome of a prior played game by viewing the previously utilized secret seed and resubmitting the client seed to the system. The system can then recalculate the hash value and disclose all steps of the calculation to the contestant. Optionally, the system may later disclose the secret seed and the client seeds received from all contestants so that any third party can view all results and verify the winner of the game without resubmitting any client seed. In this manner, the outcome of any game can be later verified by any party.

Although the verification method as described above calls for one client seed, one server seed, and one secret seed, a similar process for determining winners can also be used if there were multiple client seeds, multiple server seeds, and/or multiple secret seeds by applying a hash to the combined results. Furthermore, the client seed(s) used for the game of chance winner could also determined by the next to last, second to last, nth to last, or alternatively a randomly selected client seed or by a combination of such client seeds. The critical point here is since the winner in the game of skill is unknown in advance and hence the client seed or client seeds for the game of chance selection are unknown in advance, the game manager cannot manipulate the resulting game of chance winner.

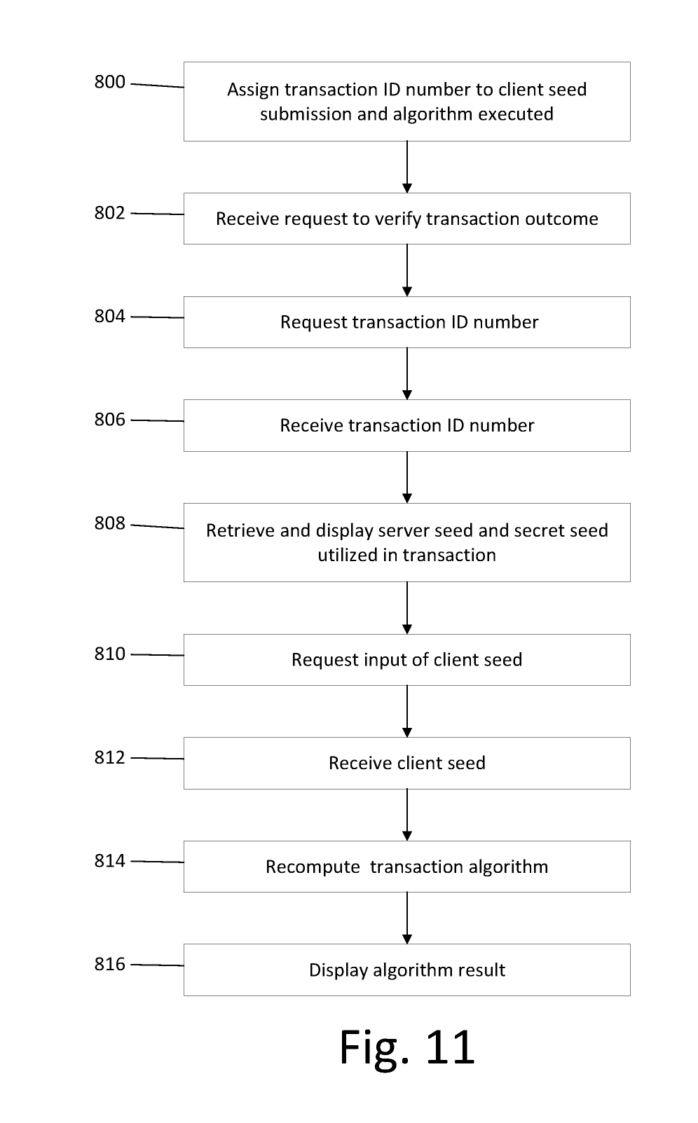

The verification method is illustrated in FIG. 11. First the system assigns a transaction ID number to each client seed value submission and algorithm executed 800. The system receives a request from a user to verify the outcome of a specific transaction 802. The system requests the transaction ID number from the user 804. The system then receives the transaction ID number from the user 806. The system retrieves and displays the server seed value and secret seed value utilized in the transaction 808. The system requests the input of a client seed from the user 810. The user may use the same client seed as before or may input a new client seed to see what would have happened if the user had changed the client seed value. The system receives the client seed value from the client computer 812. The system recomputes the transaction algorithm with a new combined seed value formed by combining the newly submitted client seed value with the original server seed value and secret seed value 814. The system displays the result of the algorithm to the user 816.

### Game Illustration

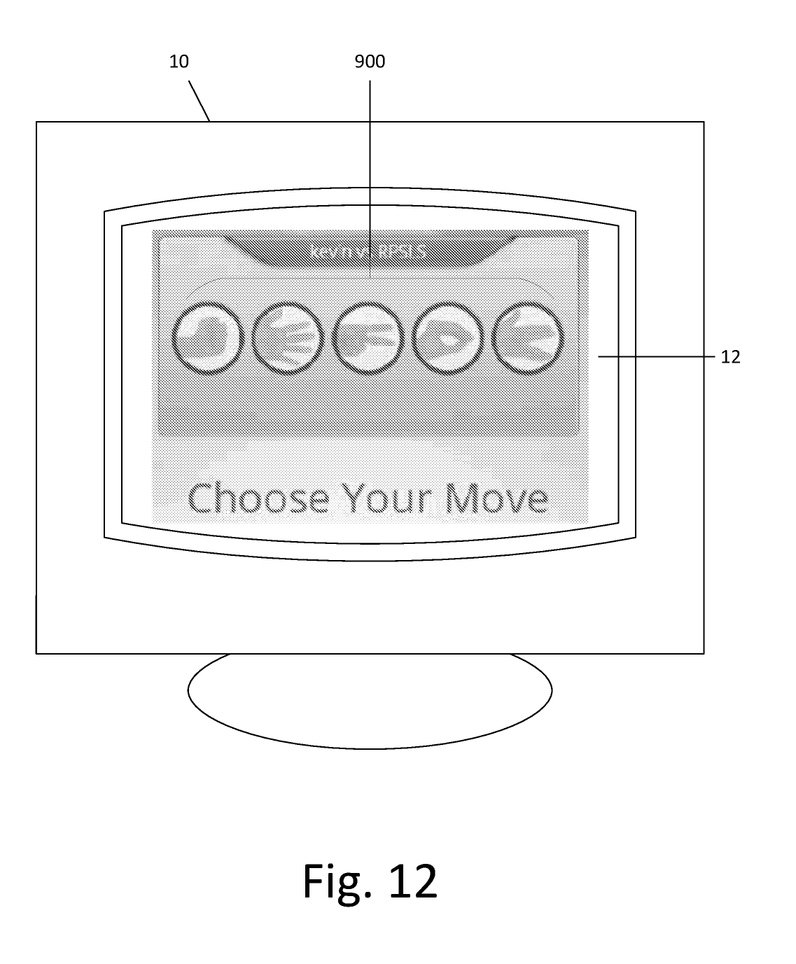

Referring to FIG. 12 through FIG. 14, an example of a game utilizing the inventive method is illustrated. The inventive method may be utilized in any type of single or multiplayer game or contest and the example illustrated should not be seen as limiting the scope of the invention.

As shown in FIG. 12, a user accesses the game via a client computer 10. The game is displayed on the display screen 12 of the client computer 10. Any type of game may be utilized for the method. The game illustrated in FIG. 12 through FIG. 14 is variation of Rock/Paper/Scissors. The system presents a selection set 900 to the user. The user chooses one of the selection set 900 as an input to the game. The client computer 10 may utilize the shape selected by the user to assist in generating the client seed, along with the specific time of day, and client computer information. When the server computer 20 receives the client seed value, the server computer 20 utilizes the client seed to determine the countermove of the A.I. The server computer 20 combines the client seed with the secret seed and server seed, hashes the combined value, and enters the hash value into a decision making algorithm with five separate outputs. The output of the algorithm dictates the countermove by the A.I. in the game.

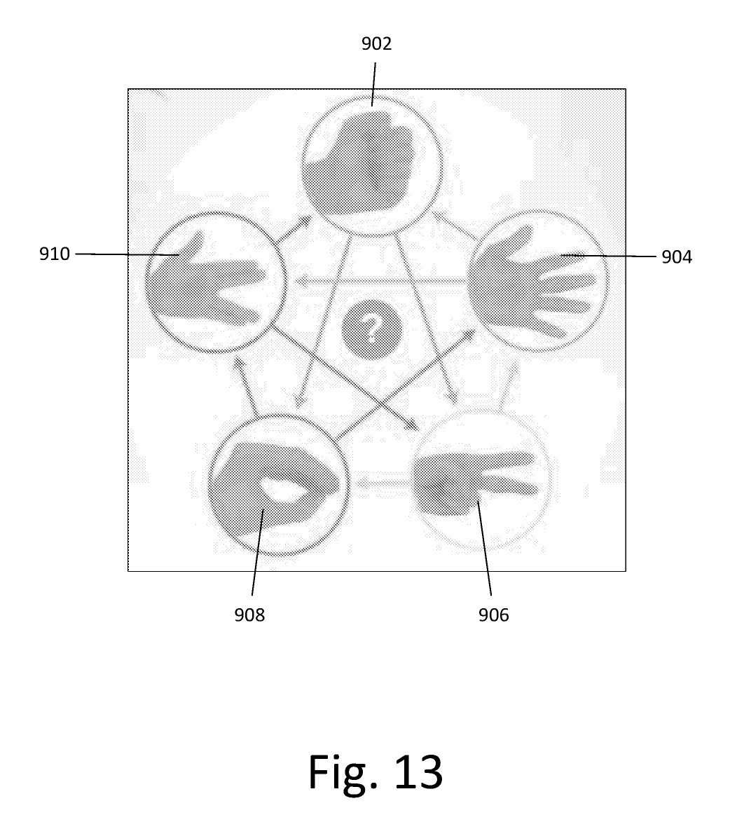

Referring to FIG. 13, the variation of Rock/Paper/Scissors is further illustrated. In this variation there are five selected moves instead of the standard three moves. A user may select to play rock 902, paper 904, scissors 906, lizard 908, or dog 910. Rock 902 beats scissors 906 and lizard 908. Paper 904 beats rock 902 and dog 910. Scissors 906 beats paper 904 and lizard 908. Lizard 908 beats paper 904 and dog 910. Dog 910 beats scissors 906 and rock 902.

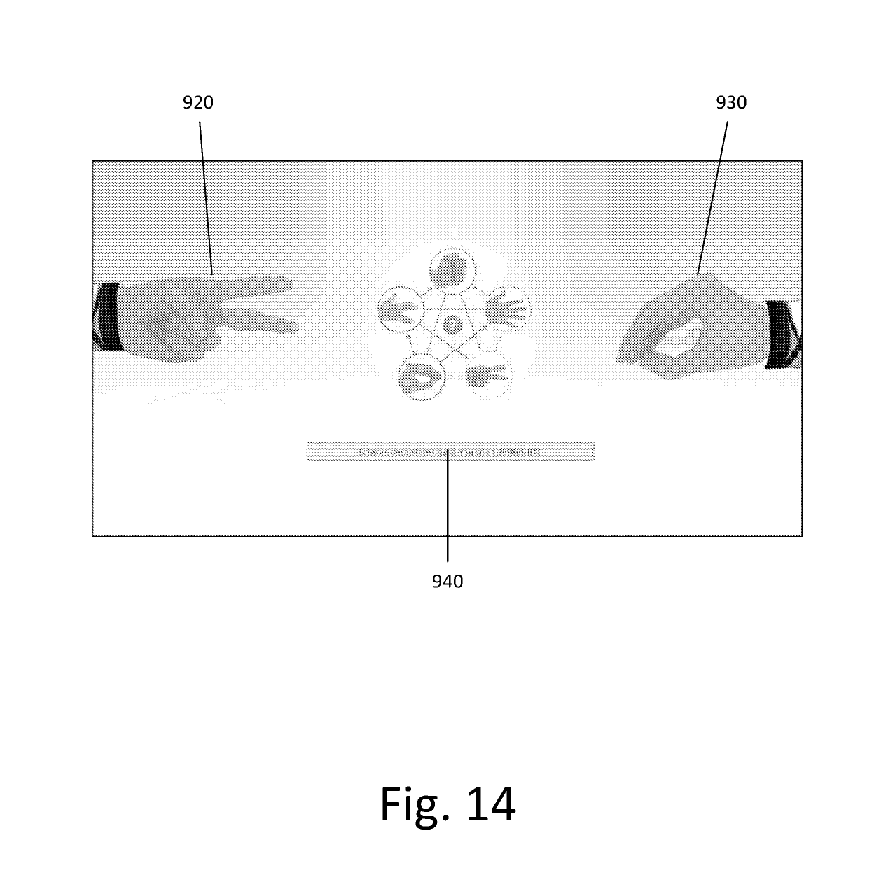

After the player selects his move, the system determines the countermove of the A.I. and displays the results to the user, as shown in FIG. 14. In this game the system displays the user's move 920. In the illustrated example, the user's move 920 is scissors 906. The system used the client seed to generate the system's countermove 930. In the illustrated example the system's countermove 930 is lizard 908. Because scissors 906 beats lizard 908, the user wins the round. Because the user wins the round, the system elects the client computer 10 as the winner and sends and election confirmation to the client computer 10. The system displays the winning results 940.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A computerized method for determining a result of a computer based contest comprising
a) receiving a client seed value;
b) generating a server seed value;
c) receiving a secret seed value;
d) combining said client seed value, said server seed value, and said secret seed value into a combined seed value;
e) entering said combined seed value into a decision making algorithm;
f) executing said decision making algorithm;
g) determining an output value of said decision making algorithm;
h) establishing a preset value range;
i) determining if said output value is within said preset value range;
j) generating an award if said output value is within said preset value range.

2) The method as in claim 1 further comprising
a) receiving said client seed value, said server seed value, and said secret seed value in Base64 format;
b) converting each of said client seed value, said server seed value, and said secret seed value respectively into a client seed value byte array, a server seed value byte array, and a secret seed value byte array;
c) concatenating said client seed value byte array, said server seed value byte array, and said secret seed value byte array into a combined byte array;
d) calculating a SHA512 hash value for said combined byte array;
e) converting said hash value into a hexadecimal string;
f) segregating a first set of characters from said hexadecimal string;
g) converting said first set of characters into a long integer;
h) identifying said long integer as said combined seed value.

3) The method as in claim 1 further comprising
a) generating a combined seed input value, wherein said combined seed input value includes at least one of a random input value, a user input value, a time value, and a client identity value
i) wherein said random input value is randomly generated by a computer;
ii) wherein said user input value is dependent upon a chosen input by a user of a computer;
iii) wherein said time value is dependent upon the time of creation of said time value;
iv) wherein said client identity value is dependent upon the identity information of a computer creating said client identity value;
b) transforming said combined seed input value into said client seed value.

4) The method as in claim 1 further comprising
a) assigning a transaction identification number to an execution of said decision making algorithm;
b) storing information related to said execution of said decision making algorithm;
c) receiving a request to verify a transaction outcome;
d) requesting input of a transaction identification number;
e) receiving an input of a transaction identification number;
f) retrieving a set of stored information related to said execution of said decision making algorithm;
g) displaying a server seed value utilized in said execution of said decision making algorithm;
h) displaying a secret seed value utilized in said execution of said decision making algorithm;
i) requesting input of a confirmation client seed value;
j) receiving a confirmation client seed value;
k) combining said confirmation client seed value, said server seed value, and said secret seed value into a confirmation combined seed value;
l) entering said confirmation combined seed value into said decision making algorithm;
m) executing said decision making algorithm;
n) determining a confirmation output value of said decision making algorithm;
o) displaying said confirmation output value on a display screen.

5) The method as in claim 2 further comprising
a) generating a combined seed input value, wherein said combined seed input value includes at least one of a random input value, a user input value, a time value, and a client identity value
i) wherein said random input value is randomly generated by a computer;
ii) wherein said user input value is dependent upon a chosen input by a user of a computer;
iii) wherein said time value is dependent upon the time of creation of said time value;
iv) wherein said client identity value is dependent upon the identity information of a computer creating said client identity value;
b) transforming said combined seed input value into said client seed value.

6) The method as in claim 5 further comprising
a) assigning a transaction identification number to an execution of said decision making algorithm;
b) storing information related to said execution of said decision making algorithm;
c) receiving a request to verify a transaction outcome;
d) requesting input of a transaction identification number;
e) receiving an input of a transaction identification number;
f) retrieving a set of stored information related to said execution of said decision making algorithm;
g) displaying a server seed value utilized in said execution of said decision making algorithm;
h) displaying a secret seed value utilized in said execution of said decision making algorithm;
i) requesting input of a confirmation client seed value;
j) receiving a confirmation client seed value;
k) combining said confirmation client seed value, said server seed value, and said secret seed value into a confirmation combined seed value;
l) entering said confirmation combined seed value into said decision making algorithm;
m) executing said decision making algorithm;
n) determining a confirmation output value of said decision making algorithm;
o) displaying said confirmation output value on a display screen.

7) A computerized method for determining a result of a computer based contest comprising
a) receiving, by a server computer, a plurality of client seed values from a plurality of client computers;
b) assigning an order value to each of said client seed values;
c) generating a server seed value;
d) receiving a secret seed value;
e) electing one or more client seed values from said plurality of client seed values;
f) combining said one or more elected client seed values, said server seed value, and said secret seed value into a combined seed value;
g) inputting said combined seed value into a decision making algorithm;
h) executing said decision making algorithm;
i) determining an output value of said decision making algorithm, wherein said output value is an integer having a lower limit value of 1 and an upper limit value equal to the number of client seed values received;
j) determining an identity of a first client computer whose assigned order value of said client seed value submitted is equal to said output value;
k) electing said first client computer for the receipt of an award;
l) generating an award to a client computer.

8) The method as in claim 7 further comprising
a) assigning a transaction identification number to an execution of said decision making algorithm;
b) storing information related to said execution of said decision making algorithm;
c) receiving a request to verify a transaction outcome;
d) requesting input of a transaction identification number;
e) receiving an input of a transaction identification number;
f) retrieving a set of stored information related to said execution of said decision making algorithm;
g) displaying a server seed value utilized in said execution of said decision making algorithm;
h) displaying a secret seed value utilized in said execution of said decision making algorithm;
i) requesting input of a confirmation client seed value;
j) receiving a confirmation client seed value;
k) combining said confirmation client seed value, said server seed value, and said secret seed value into a confirmation combined seed value;
l) entering said confirmation combined seed value into said decision making algorithm;
m) executing said decision making algorithm;
n) determining a confirmation output value of said decision making algorithm;
o) displaying said confirmation output value on a display screen.

9) The method as in claim 7 further comprising
a) placing an award restriction on a client computer;
b) saving said award restriction as an award restriction data file in a database on a server computer.

10) The method as in claim 9 further comprising
a) searching a database containing award restriction data files on a server computer;
b) determining if an award restriction data file identifying said first client computer exists in said database;
c) cancelling said election of said first client computer for the receipt of an award;
d) electing one or more alternate client seed values from said plurality of client seed values;
e) combining said one or more elected alternate client seed values, said server seed value, and said secret seed value into an alternate combined seed value;
f) inputting said alternate combined seed value into a decision making algorithm;
g) executing said decision making algorithm;
h) determining an alternate output value of said decision making algorithm, wherein said alternate output value is an integer having a lower limit value of 1 and an upper limit value equal to the number of client seed values received;
i) determining an identity of an alternate client computer whose assigned order value of said client seed value submitted is equal to said alternate output value;
j) electing said alternate client computer for the receipt of an award.

11) The method as in claim 7 further comprising
a) receiving a client seed value, said server seed value, and said secret seed value in Base64 format;
b) converting each of said client seed value, said server seed value, and said secret seed value respectively into a client seed value byte array, a server seed value byte array, and a secret seed value byte array;
c) concatenating said client seed value byte array, said server seed value byte array, and said secret seed value byte array into a combined byte array;
d) calculating a SHA512 hash value for said combined byte array;
e) converting said hash value into a hexadecimal string;
f) segregating a first set of characters from said hexadecimal string;
g) converting said first set of characters into a long integer;
h) identifying said long integer as said combined seed value.

12) The method as in claim 7 further comprising
a) generating a combined seed input value, wherein said combined seed input value includes at least one of a random input value, a user input value, a time value, and a client identity value
i) wherein said random input value is randomly generated by a computer;
ii) wherein said user input value is dependent upon a chosen input by a user of a computer;
iii) wherein said time value is dependent upon the time of creation of said time value;
iv) wherein said client identity value is dependent upon the identity information of a computer creating said client identity value;
b) transforming said combined seed input value into a client seed value.

13) The method as in claim 12 further comprising
a) placing an award restriction on a client computer;
b) saving said award restriction as an award restriction data file in a database on a server computer;
c) searching a database containing award restriction data files on a server computer;
d) determining if an award restriction data file identifying said first client computer exists in said database;
e) cancelling said election of said first client computer for the receipt of an award;
f) electing one or more alternate client seed values from said plurality of client seed values;
g) combining said one or more elected alternate client seed values, said server seed value, and said secret seed value into an alternate combined seed value;
h) inputting said alternate combined seed value into a decision making algorithm;
i) executing said decision making algorithm;
j) determining an alternate output value of said decision making algorithm, wherein said alternate output value is an integer having a lower limit value of 1 and an upper limit value equal to the number of client seed values received;
k) determining an identity of an alternate client computer whose assigned order value of said client seed value submitted is equal to said alternate output value;
l) electing said alternate client computer for the receipt of an award.

14) The method as in claim 13 further comprising
a) receiving a client seed value, said server seed value, and said secret seed value in Base64 format;
b) converting each of said client seed value, said server seed value, and said secret seed value respectively into a client seed value byte array, a server seed value byte array, and a secret seed value byte array;
c) concatenating said client seed value byte array, said server seed value byte array, and said secret seed value byte array into a combined byte array;
d) calculating a SHA512 hash value for said combined byte array;
e) converting said hash value into a hexadecimal string;
f) segregating a first set of characters from said hexadecimal string;
g) converting said first set of characters into a long integer;
h) identifying said long integer as said combined seed value;
i) assigning a transaction identification number to an execution of said decision making algorithm;
j) storing information related to said execution of said decision making algorithm;
k) receiving a request to verify a transaction outcome;
l) requesting input of a transaction identification number;
m) receiving an input of a transaction identification number;
n) retrieving a set of stored information related to said execution of said decision making algorithm;
o) displaying a server seed value utilized in said execution of said decision making algorithm;
p) displaying a secret seed value utilized in said execution of said decision making algorithm;
q) requesting input of a confirmation client seed value;
r) receiving a confirmation client seed value;
s) combining said confirmation client seed value, said server seed value, and said secret seed value into a confirmation combined seed value;
t) entering said confirmation combined seed value into said decision making algorithm;
u) executing said decision making algorithm;
v) determining a confirmation output value of said decision making algorithm;
w) displaying said confirmation output value on a display screen.

15) A computerized method for determining a result of a computer based contest comprising
a) receiving, by a server computer, a plurality of client seed values from a plurality of client computers;
b) assigning an order value to each of said client seed values;
c) select a predetermined order value;
d) determining the identity of a first client computer whose assigned order value of said client seed value submitted it equal to said predetermined order value;
e) electing said first client computer for the receipt of an award;
f) generating an award to said first client computer;
g) generating a server seed value;
h) receiving a secret seed value;
i) electing one or more client seed values from said plurality of client seed values;
j) combining said one or more elected client seed values, said server seed value, and said secret seed value into a combined seed value;
k) inputting said combined seed value into a decision making algorithm;
l) executing said decision making algorithm;
m) determining an output value of said decision making algorithm, wherein said output value is an integer having a lower limit value of 1 and an upper limit value equal to the number of client seed values received;
n) determining an identity of a second client computer whose assigned order value of said client seed value submitted is equal to said output value;
o) electing said second client computer for the receipt of an award
p) generating an award to said second client computer.

16) The method as in claim 15 further comprising
a) placing an award restriction on a client computer;
b) saving said award restriction as an award restriction data file in a database on a server computer.

17) The method as in claim 16 further comprising
a) searching a database containing award restriction data files on a server computer;
b) determining if an award restriction data file identifying an elected client computer exists in said database;
c) cancelling said election of said elected client computer for the receipt of an award;

18) The method as in claim 17 further comprising
a) selecting an alternate predetermined order value when said first client computer is identified as having an award restriction;
b) determining the identity of an alternate first client computer whose assigned order value of said client seed value submitted it equal to said alternate predetermined order value;
c) electing said alternate first client computer for the receipt of an award;
d) generating an award to said alternate first client computer.

19) The method as in claim 17 further comprising
a) electing one or more alternate client seed values from said plurality of client seed values when said second client computer is identified as having an award restriction;
b) combining said one or more elected alternate client seed values, said server seed value, and said secret seed value into an alternate combined seed value;
c) inputting said alternate combined seed value into a decision making algorithm;
d) executing said decision making algorithm;
e) determining an alternate output value of said decision making algorithm, wherein said alternate output value is an integer having a lower limit value of 1 and an upper limit value equal to the number of client seed values received;
f) determining an identity of an alternate client computer whose assigned order value of said client seed value submitted is equal to said alternate output value;
g) electing said alternate client computer for the receipt of an award.

20) The method as in claim 15 further comprising
a) generating a combined seed input value, wherein said combined seed input value includes at least one of a random input value, a user input value, a time value, and a client identity value
i) wherein said random input value is randomly generated by a computer
ii) wherein said user input value is dependent upon a chosen input by a user of a computer
iii) wherein said time value is dependent upon the time of creation of said time value
iv) wherein said client identity value is dependent upon the identity information of a computer creating said client identity value
b) transforming said combined seed input value into a client seed value;
c) receiving a client seed value, said server seed value, and said secret seed value in Base64 format;
d) converting each of said client seed value, said server seed value, and said secret seed value respectively into a client seed value byte array, a server seed value byte array, and a secret seed value byte array;
e) concatenating said client seed value byte array, said server seed value byte array, and said secret seed value byte array into a combined byte array;
f) calculating a SHA512 hash value for said combined byte array;
g) converting said hash value into a hexadecimal string;
h) segregating a first set of characters from said hexadecimal string;
i) converting said first set of characters into a long integer;
j) identifying said long integer as said combined seed value.
